(19) United States
(12) Patent Application Publication
(10) Pub. No.: US 2025/0335331 A1
(43) Pub. Date: Oct. 30, 2025

(54) CODE QUALITY MANAGEMENT USING MACHINE LEARNING

(71) Applicant: Dell Products L.P., Round Rock, TX (US)

(72) Inventors: Tamilarasan Janakiraman, Rochestown (IE); Kakasaheb Waghmare, Poznan (PL); Kishore Gowrav Ramesh Babu, Mysore (IN)

(21) Appl. No.: 18/644,573

(22) Filed: Apr. 24, 2024

(51) Int. Cl. G06F 11/36; G06N 20/00

(52) U.S. Cl. CPC G06F 11/3608; G06N 20/00

(57) ABSTRACT

A method comprises causing scanning of at least a portion of code in response to one or more changes to the code, processing data generated as a result of the scanning, and analyzing the data using at least one machine learning algorithm to predict whether the one or more changes will cause a reduction in quality of the code. In response to a prediction that the one or more changes will cause a reduction in the quality of the code, a placeholder in a code development application to address the reduction is generated.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The field relates generally to information processing systems, and more particularly to code quality management in information processing systems.

### BACKGROUND

Software development objectives include maintaining high code quality and adhering to established standards. Conventional systems for software development, however, lack capabilities to monitor and sustain the quality of code and to ensure conformity with the established standards over time. As a result, code quality issues often go unaddressed, leading to a cascade of unforeseen complications in the development process.

### SUMMARY

Embodiments provide a code quality management platform in an information processing system.

For example, in one embodiment, a method comprises causing scanning of at least a portion of code in response to one or more changes to the code, processing data generated as a result of the scanning, and analyzing the data using at least one machine learning algorithm to predict whether the one or more changes will cause a reduction in quality of the code. In response to a prediction that the one or more changes will cause a reduction in the quality of the code, a placeholder in a code development application to address the reduction is generated.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 depicts an information processing system with a code quality management platform according to an illustrative embodiment.

FIG. 2 depicts an operational flow for code quality management according to an illustrative embodiment.

FIG. 3 depicts examples of primary and foreign keys for code-related data stored in a database according to an illustrative embodiment.

FIG. 4 depicts examples of databases, schemas and other types of configurations for code-related data stored in a database according to an illustrative embodiment.

FIG. 5 depicts examples of schemas and other types of configurations for code-related data stored in a database.

FIG. 6 depicts example pseudocode for importation of libraries, loading code-related data into a data frame and sorting code-related data according to an illustrative embodiment.

FIG. 7 depicts an example of a table of sorted code-related data according to an illustrative embodiment.

FIG. 8A depicts example pseudocode for changing values of code-related data according to an illustrative embodiment.

FIG. 8B depicts examples of changed values of code-related data according to an illustrative embodiment.

FIG. 9 depicts example pseudocode for encoding and saving training and testing data samples according to an illustrative embodiment.

FIG. 10A depicts example pseudocode for splitting a dataset into training and testing components and for creating separate datasets for independent and dependent variables according to an illustrative embodiment.

FIG. 10B depicts a table of sample training data according to an illustrative embodiment.

FIG. 11 depicts example pseudocode for building a random forest regression model according to an illustrative embodiment.

FIG. 12A depicts example pseudocode for generating predicted values of a machine learning model and actual values according to an illustrative embodiment.

FIG. 12B depicts a table of predicted values of a machine learning model and actual values according to an illustrative embodiment.

FIG. 13A depicts example pseudocode for continuously applying machine learning prediction to an enterprise copy data management (eCDM) repository according to an illustrative embodiment.

FIG. 13B depicts a plot of results of continuously applying machine learning prediction to an eCDM repository according to an illustrative embodiment.

FIGS. 14A and 14B depict example pseudocode for creating a placeholder in a code development application indicating a code issue according to an illustrative embodiment.

FIG. 15 depicts a screenshot of a placeholder for a code development application indicating a code issue according to an illustrative embodiment.

FIG. 16 depicts a process for code quality management according to an illustrative embodiment.

FIGS. 17 and 18 show examples of processing platforms that may be utilized to implement at least a portion of an information processing system according to illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Such systems are considered examples of what are more generally referred to herein as cloud-based computing environments. Some cloud infrastructures are within the exclusive control and management of a given enterprise, and therefore are considered “private clouds.” The term “enterprise” as used herein is intended to be broadly construed, and may comprise, for example, one or more businesses, one or more corporations or any other one or more entities, groups, or organizations. An “entity” as illustratively used herein may be a person or system. On the other hand, cloud infrastructures that are used by multiple enterprises, and not necessarily controlled or managed by any of the multiple enterprises but rather respectively controlled and managed by third-party cloud providers, are typically considered “public clouds.” Enterprises can choose to host their applications or services on private clouds, public clouds, and/or a combination of private and public clouds (hybrid clouds) with a vast array of computing resources attached to or otherwise a part of the infrastructure. Numerous other types of enterprise computing and storage systems are also encompassed by the term “information processing system” as that term is broadly used herein.

As used herein, “real-time” refers to output within strict time constraints. Real-time output can be understood to be instantaneous or on the order of milliseconds or microseconds. Real-time output can occur when the connections with a network are continuous and a developer device receives messages without any significant time delay. Of course, it should be understood that depending on the particular temporal nature of the system in which an embodiment is implemented, other appropriate timescales that provide at least contemporaneous performance and output can be achieved.

As used herein, “application programming interface (API)” refers to a set of subroutine definitions, protocols, and/or tools for building software. Generally, an API defines communication between software components. APIs permit software applications to be written so as to be consistent with an operating environment or website. In a non-limiting example, APIs enable software components to communicate with each other using designated definitions and protocols.

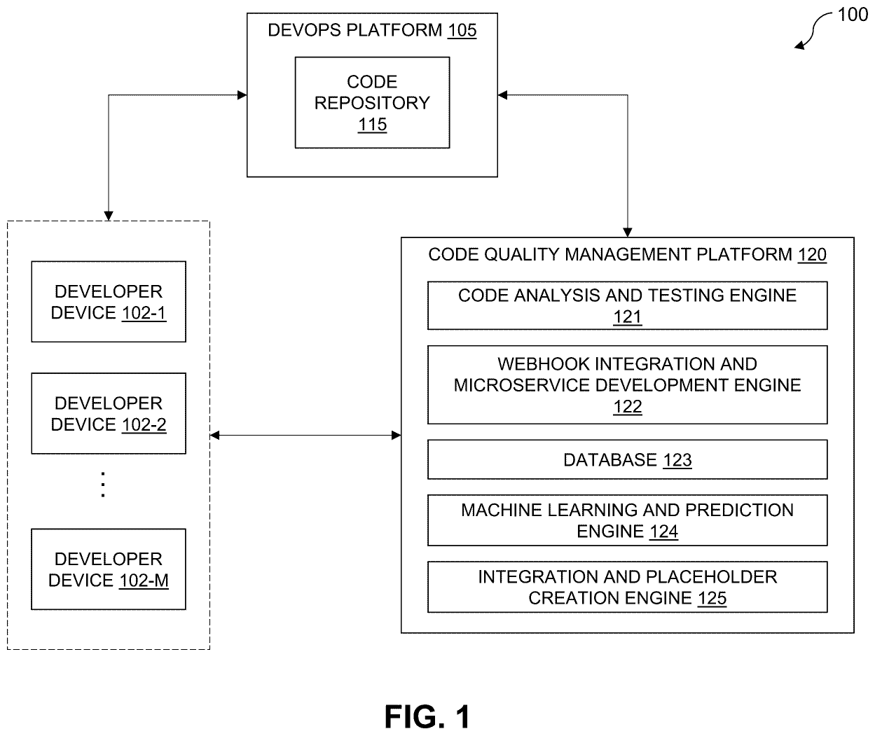

FIG. 1 shows an information processing system 100 configured in accordance with an illustrative embodiment. The information processing system 100 comprises developer devices 102-1, 102-2, . . . 102-M (collectively “developer devices 102”), at least one development and information technology operations (DevOps) platform 105 and a code quality management platform 120. The developer devices 102, DevOps platform 105 and code quality management platform 120 communicate with each other over a network as shown by the arrows connecting the developer devices 102, DevOps platform 105 and code quality management platform 120. The variable M and other similar index variables herein such as K and L are assumed to be arbitrary positive integers greater than or equal to one.

The developer devices 102 and one or more devices of the DevOps platform 105 can comprise, for example, Internet of Things (IoT) devices, server, desktop, laptop or tablet computers, mobile telephones, or other types of processing devices capable of communicating with the code quality management platform 120 over the network. Such devices are examples of what are more generally referred to herein as “processing devices.” Some of these processing devices are also generally referred to herein as “computers.” The developer devices 102 and one or more devices of the DevOps platform 105 may also or alternately comprise virtualized computing resources, such as virtual machines (VMs), containers, etc. The developer devices 102 and/or one or more devices of the DevOps platform 105 in some embodiments comprise respective computers associated with a particular company, organization or other enterprise.

The terms “developer,” “administrator,” “personnel” or “user” herein are intended to be broadly construed so as to encompass numerous arrangements of human, hardware, software or firmware entities, as well as combinations of such entities. Code quality management services may be provided for users utilizing one or more machine learning models, although it is to be appreciated that other types of infrastructure arrangements could be used. At least a portion of the available services and functionalities provided by the code quality management platform 120 in some embodiments may be provided under Function-as-a-Service (“FaaS”), Containers-as-a-Service (“CaaS”) and/or Platform-as-a-Service (“PaaS”) models, including cloud-based FaaS, CaaS and PaaS environments.

Although not explicitly shown in FIG. 1, one or more input-output devices such as keyboards, displays or other types of input-output devices may be used to support one or more user interfaces to the code quality management platform 120, as well as to support communication between the code quality management platform 120 and connected devices (e.g., developer devices 102 and one or more devices of the DevOps platform 105) and/or other related systems and devices not explicitly shown.

In some embodiments, the developer devices 102 are assumed to be associated with repair technicians, system administrators, information technology (IT) managers, software developers, release management personnel or other authorized personnel configured to access and utilize the code quality management platform 120. The developer devices 102 can also be respectively associated with one or more users requiring the services of the DevOps platform 105 and/or code quality management platform 120. An example of a DevOps platform is GitLab®.

Agile development refers to a project management methodology that relies on collaboration and individual interactions to create software. An agile dashboard (or agile board) provides an electronic visual representation of an agile development process and illustrates, for example, a status of each task, group related tasks and progress toward completion of each task. An agile board further depicts the software development cycle and organizational structure. As noted hereinabove, software development objectives include maintaining high code quality and adhering to established standards, and conventional systems for software development (e.g., conventional agile dashboards) lack capabilities to monitor and sustain the quality of code and to ensure conformity with the established standards over time.

Agile methodologies emphasize flexibility, collaboration, and responsiveness to changing requirements. Agile dashboards provide visibility into project progress, enabling real-time decision-making, and fostering collaboration among team members. However, one critical aspect that agile dashboards and other conventional software development approaches have struggled to effectively address is the comprehensive monitoring of code quality and adherence to coding standards. While agile methodologies prioritize delivering functional software in shorter cycles, they fail at maintaining high code quality over time. This limitation has significant implications for software development projects, where the longevity, reliability, and maintainability of the codebase are of paramount importance.

In practice, developers routinely contribute code to a version control system (SVC), an expect code scanning tools to evaluate code quality and identify issues. However, when discrepancies in code quality arise, they are often left unaddressed with conventional approaches. As a result, these code quality issues persist, accumulating over time and compromising the overall quality of the software. The consequence of this gap in code quality monitoring is that software projects face an elevated risk of quality degradation. Developers may inadvertently produce more code with lower code coverage, creating a ripple effect of software quality deterioration. This can manifest as an increased incidence of bugs, reduced reliability, and higher maintenance costs.

In order to address the problems with current approaches, illustrative embodiments provide technical solutions that seamlessly integrate code quality assessment and adherence to standards into current approaches (e.g., agile dashboards). By bridging this divide, the embodiments advantageously empower software development teams to proactively manage and enhance code quality, ultimately bolstering the success and reliability of software projects in the long term. The embodiments advantageously provide a code quality management framework that continuously monitors code repositories for changes to code and uses machine learning to intelligently evaluate the changes to predict whether the changes are causing code quality to deteriorate.

The code quality management platform 120 in the present embodiment is assumed to be accessible to the developer devices 102 and/or DevOps platform 105 and vice versa over a network. The network is assumed to comprise a portion of a global computer network such as the Internet, although other types of networks can be part of the network, including a wide area network (WAN), a local area network (LAN), a satellite network, a telephone or cable network, a cellular network, a wireless network such as a WiFi or WiMAX network, or various portions or combinations of these and other types of networks. The network in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

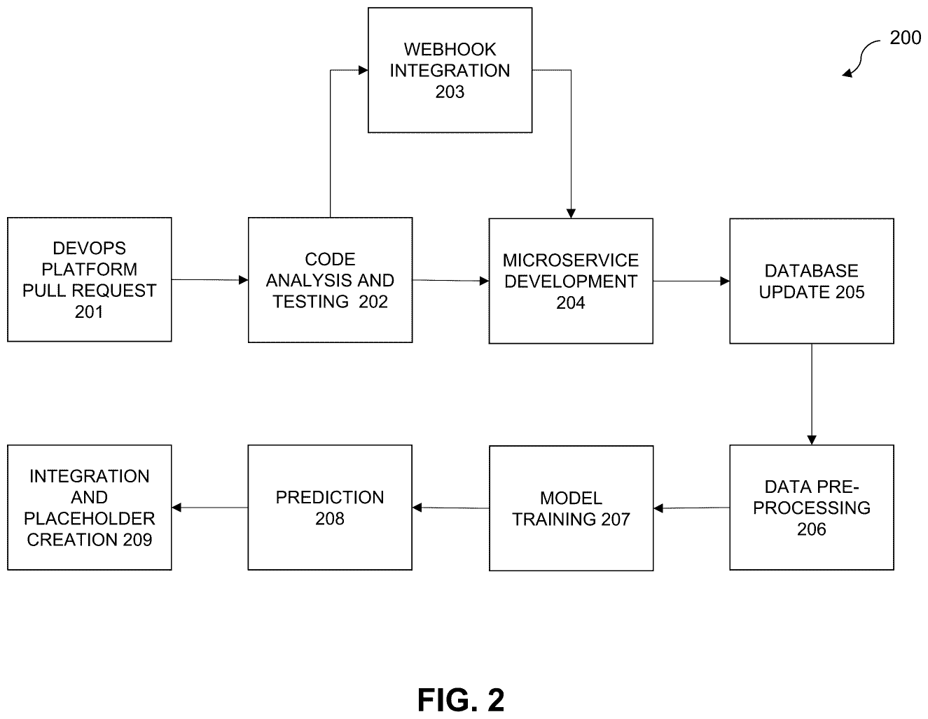

Referring to FIG. 1, the code quality management platform 120 includes a code analysis and testing engine 121, a webhook integration and microservice development engine 122, a database 123, a machine learning and prediction engine 124 and an integration and placeholder creation engine 125. Referring to the operational flow 200 in FIG. 2 in conjunction with the information processing system 100 in FIG. 1, the code quality management platform 120 continuously monitors a code repository 115 of the DevOps platform 105 to determine whether any changes or proposed changes to code have been made. For example, in illustrative embodiments, the code quality management platform 120 continuously monitors a code repository 115 and/or a version control system to identify whether any pull requests have been made. As used herein, a “pull request” can refer to a proposed change to code to be integrated into a codebase. The pull request may comprise a proposal to merge changes from a source branch of the code to a target branch of the code. Collaborators can review and discuss the proposed changes before integrating the changes into the codebase. In some embodiments, pull requests display the differences between content in a source branch and a target branch. Pull requests may be created by developers through web-based interfaces, desktop interfaces, codespace interfaces, mobile interfaces and/or command-line interfaces (CLIs) to the DevOps platform 105. In one or more embodiments, the code quality management platform 120 continuously monitors a version control system to determine whether any changes or proposed changes to code have been made have been made.

Referring to steps 201 and 202 of the operational flow 200, in response to a DevOps platform pull request or other detected change or proposed change to code, code analysis and testing is performed. In more detail, the code analysis and testing engine 121 causes scanning of at least a portion of code in response to a detected change or proposed change to the code. In a non-limiting illustrative example, each time a pull request is made, the code analysis and testing engine 121, which may include one or more continuous integration tools, executes critical tasks, including running unit tests and performing or causing performance of a code scan. For example, the code analysis and testing engine 121 integrates tools which create workflows to automatically test code. The tools may create workflows using, for example, declarative pipelines, workflow files, step collections, jobs to group steps or individual commands and container-based builds. In addition, the code analysis and testing engine 121 integrates tools which scan and analyze code to detect bugs and code issues in multiple programming languages, and issue reports on regarding, for example, duplicated code, coding standards, unit tests, code coverage, code complexity, comments, bugs, and security recommendations. Some examples of tools that may be integrated with the code analysis and testing engine 121 include Jenkins®, GitHub® Actions and a code scanning application such as SonarQube®. In some embodiments, the code analysis and testing engine 121 may independently (e.g., without the integration tools described herein) execute critical tasks, including creating workflows, running unit tests and performing a code scan with its own workflow creations, unit test and/or code scanning applications.

Referring to steps 203 and 204 in the operational flow 200, the webhook integration and microservice development engine 122 integrates a webhook with at least one code scanning application to trigger processing and loading data generated as a result of the code scanning to the database 123. As used herein, a “webhook” refers to a mechanism for automatic delivery of data to, for example, a server or other device, in response to a designated event (e.g., code scan) occurring in a software system. Webhooks allow for the real-time receipt of data in response to the occurrence of the designated event. A webhook can be configured to cause delivery of the data each time the designated event occurs. The creation of a webhook includes specification of a uniform resource locator (URL) and subscribing to events. In illustrative embodiments, the event is a code scan occurring on a code scanning application. When the event that the webhook is subscribed to occurs, the application will send an HTTP request with data about the event to the specified URL. If a server (e.g., a server on which the webhook integration and microservice development engine 122 is running) is configured to listen for webhook deliveries at that URL, the server will perform one or more actions (e.g., trigger the processing and loading of the code scan data to the database 123).

Referring to step 204 (microservice development), the one or more actions performed by the webhook integration and microservice development engine 122 also include developing at least one application programming interface (API) to process and load the data into the database 123. In one or more embodiments, the database 123 comprises a structured query language (SQL) database such as a PostgreSQL database.

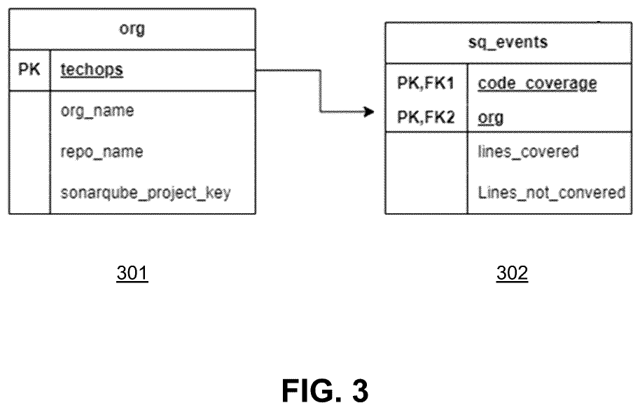

In illustrative embodiments, the API is configured to be part of at least one microservice that uses one or more object-relational mapping (ORM) techniques to enable input-output operations on the database 123. The input-output operations comprise, for example, create, read, update and delete (CRUD) operations. In illustrative embodiments, the at least one microservice is developed using a web-based API generation platform corresponding to at least one programming language. A non-limiting example of the web-based API generation platform is FastAPI®, where the corresponding programming language includes, for example, Python. The at least one microservice supports a plurality of schemas and a plurality of data types so that storage of various data types and information retrieved from the code scan application can be implemented. For example, FIG. 3 depicts examples of primary and foreign keys for code-related data that may be generated from a code scan (e.g., SonarQube® scan) and which may be stored in the database 123. The data includes tables 301 and 302 categorized under “org” and “sq_events” labels. In more detail, FIG. 3 illustrates a relational database schema implemented in PostgreSQL. The database is utilized to store a collection of scan results retrieved from SonarQube®. The table 301 stores entities referred to as “org”, which represent different organizations within GitHub® repositories or other code repository 115. The table 302 represents scans performed against a specific “org”. Each organization encompasses multiple repositories, each of which may have undergone various scans yielding metrics such as code coverage, lines covered by unit tests, and lines not covered by introduced unit tests.

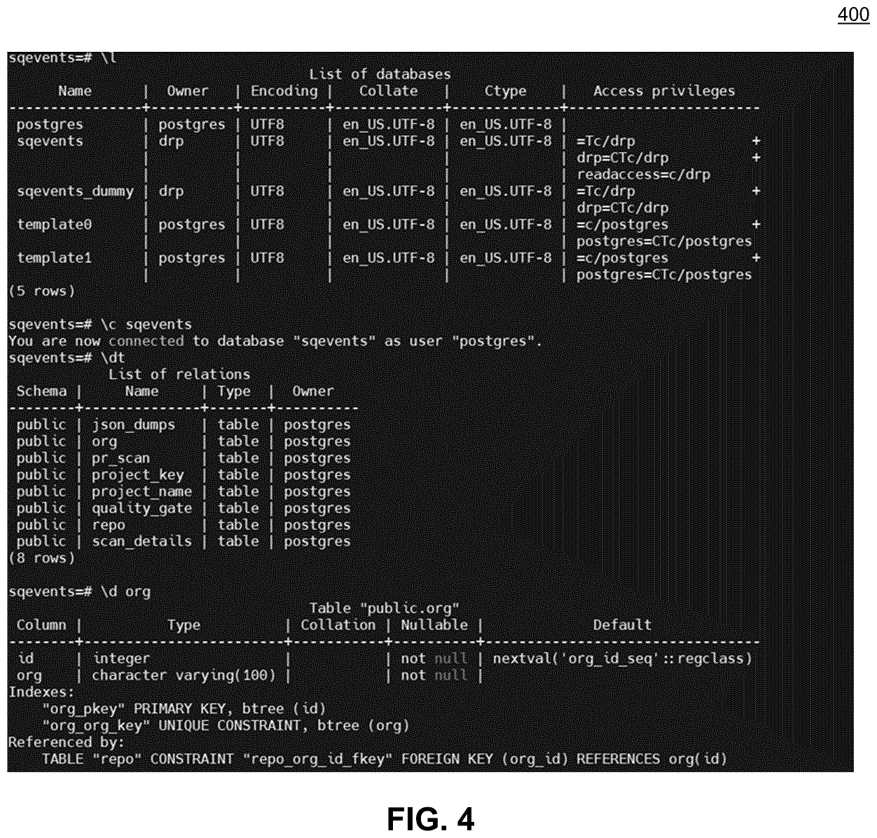

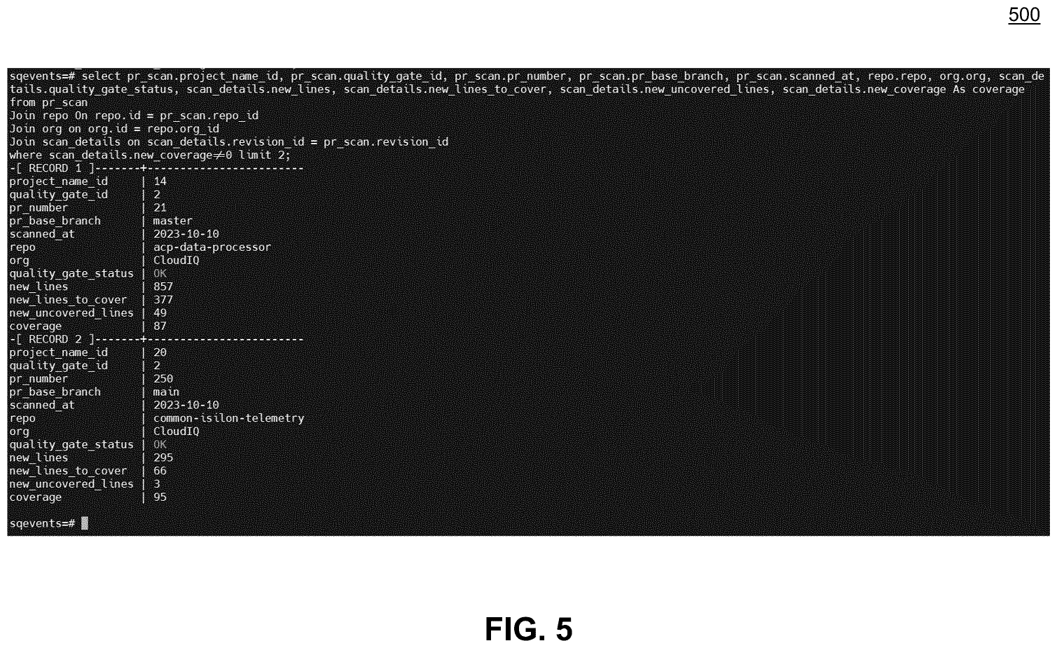

FIGS. 4 and 5 depict screenshots 400 and 500 illustrating examples of databases, schema definitions for tables and/or other types of configurations for code-related data that may be generated from a code scan and which may be stored in the database 123. In step 205, the database 123 is updated to include the data from each scan.

Referring back to steps 201 and 202 of the operational flow 200, as noted herein above, each time a pull request is made, the code analysis and testing engine 121 executes critical tasks, including creating workflows, running unit tests and performing or causing performance of a code scan. In some embodiments, a webhook may be used to trigger execution of the critical tasks when code is pushed to the code repository 115 and/or a version control system or a pull request is opened.

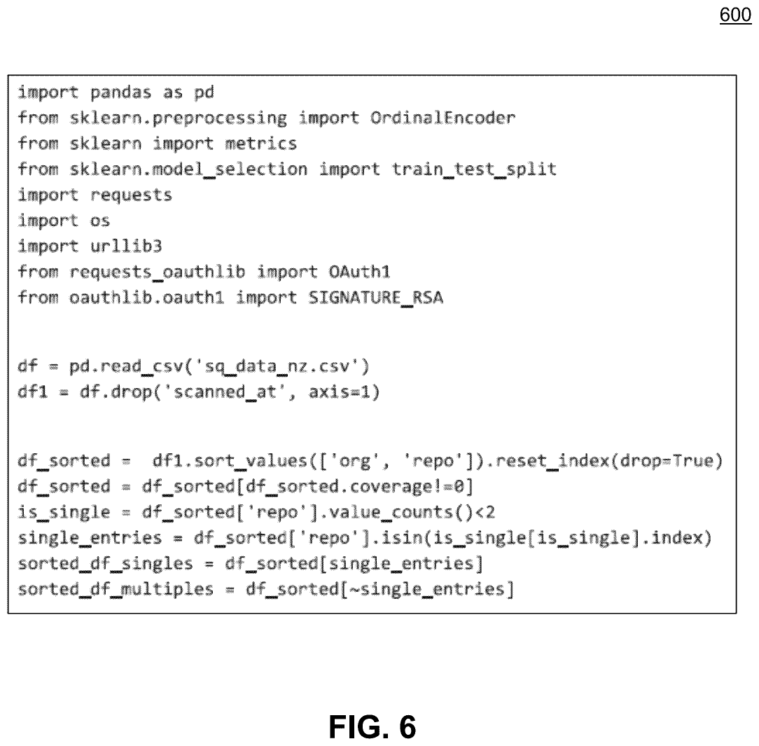

Once the data is safely stored in the database 123, the data is harnessed (e.g. extracted) for a machine learning (ML) phase. Referring to step 206, essential data pre-processing steps are performed to prepare the data for model training (step 207) and/or prediction (step 208). In more detail, referring to the pseudocode 600 in FIG. 6, importation of libraries used to implement the machine learning and prediction engine 124 include, for example, ScikitLearn, Pandas, URL and/or OAuth1 libraries. The pseudocode 600 further illustrates loading code-related data into a data frame. For example, the code-related data can be loaded into a Pandas data frame for building the training data. The data may be in the form of a CSV file. The pseudocode 600 in FIG. 6 further illustrates sorting code-related data.

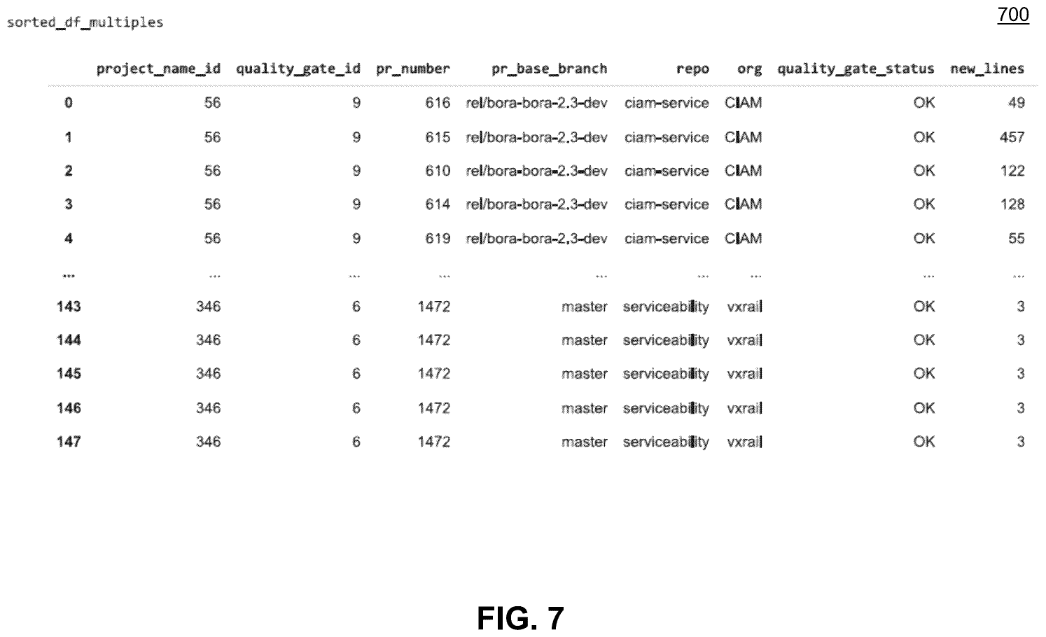

FIG. 7 depicts an example of a table 700 of sorted code-related data according to an illustrative embodiment. In more detail, the table 700 depicts raw data collected for machine learning training and testing. Each column in the table 700 represents the following:
1. project_name_id: A unique identifier for each project within the SonarQube® system to distinguish between different projects.
2. quality_gate_id: A unique identifier for a quality gate associated with the project in SonarQube®. Quality gates are a set of threshold measures designated for a project such as, for example, code coverage, technical debt measure, etc.
3. pr_number: Numerical identifier for each GitHub pull request to track changes proposed in a codebase.
4. pr_base_branch: Represents the base branch of code associated with each GitHub pull request. It is the branch where changes will be merged upon approval of the pull request.
5. repo: Signifies the specific GitHub repository with which each pull request is associated, and is used to identify the codebase undergoing changes.
6. org: Represents he GitHub organization under which the pull request falls. Facilitates categorization of repositories under different organizational structures.
7. quality_gate_status: Indicates the status of the quality gate for each project in SonarQube®. Provides a quick overview of code quality by checking if certain quality criteria have been met.
8. new_lines: The count of lines newly introduced in the codebase as part of a pull request. Facilitates understanding the extent of changes made.

Additional columns for the table 700 that are not shown in FIG. 7 may include:
9. new_lines_to_cover: The count of newly introduced lines that were covered during a scan. Provides details regarding how much of the new code is tested.
10. new_uncovered_lines: The count of newly introduced lines that were not covered during a scan. Provides details regarding how much of the new code was not tested.
11. coverage: The coverage score as determined by SonarQube® for a project.

Data pre-processing can be performed to identify important features of the code scan data and metadata. In more detail, a training dataset is read and a data frame (e.g., Pandas data frame) corresponding to the training dataset is generated. The data frame comprises a plurality of partitioned independent variables (e.g., partitioned in columns) representing the input features and the dependent/target variable columns. An initial step is to pre-process the data to address any null or missing values in the partitions (e.g., columns). Null and/or missing values in partitions with numerical data can be replaced by the median value of that partition or other average value (e.g., mean).

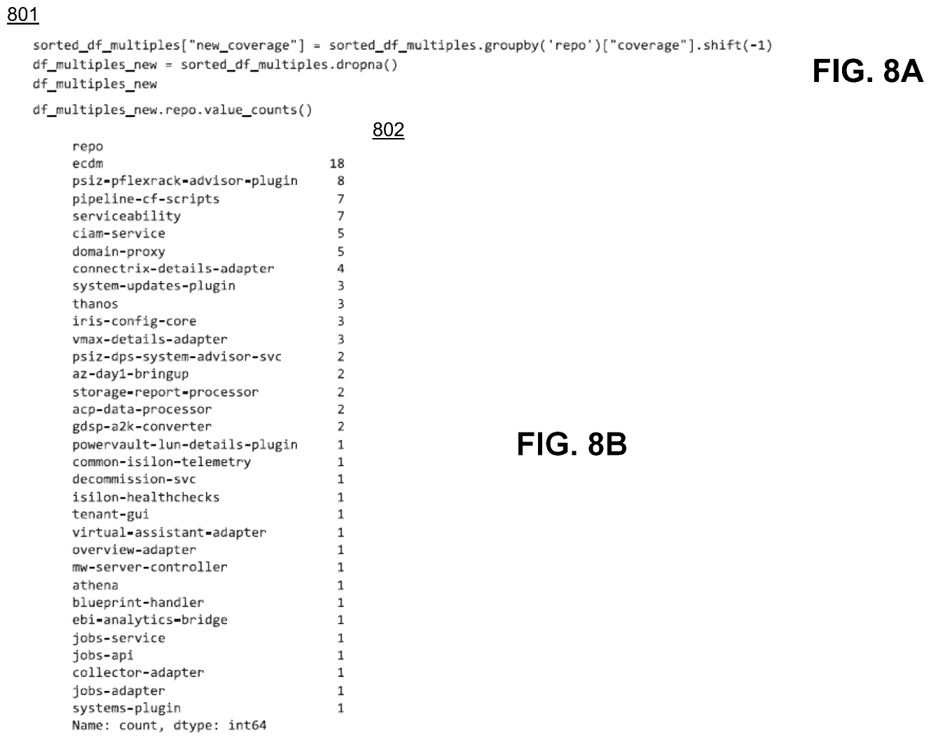

FIG. 8A depicts example pseudocode 801 for changing values of code-related data, and FIG. 8B depicts a table 802 with examples of changed values of code-related data. In more detail, the pseudocode 801 comprises a Python code snippet pertaining to the alignment of data for model training. Coverage results for each repository are aggregated. In order to train the model, most recent coverage data is utilized and an evaluation is performed if the model produces the anticipated results. The table 802 depicts the amassed dataset, which comprises repositories and their corresponding scans. For instance, “ecdm” is one such repository for which 18 scan reports have been collected. This dataset is prepared for input into the machine learning model.

After generating univariate and/or bivariate plots of the partitions, the importance and influence of each partition is determined. Partitions that have little or no role or influence on the actual prediction (target variables) can be dropped. In other words, one or more of a plurality of partitioned independent variables are identified to be removed from the training dataset based at least in part on whether the one or more of the plurality of partitioned independent variables factor into the prediction of whether changes made to code are causing a reduction in quality of the code. The identified one or more of the plurality of partitioned independent variables are removed from the training dataset, and the machine learning model is trained with the modified training dataset.

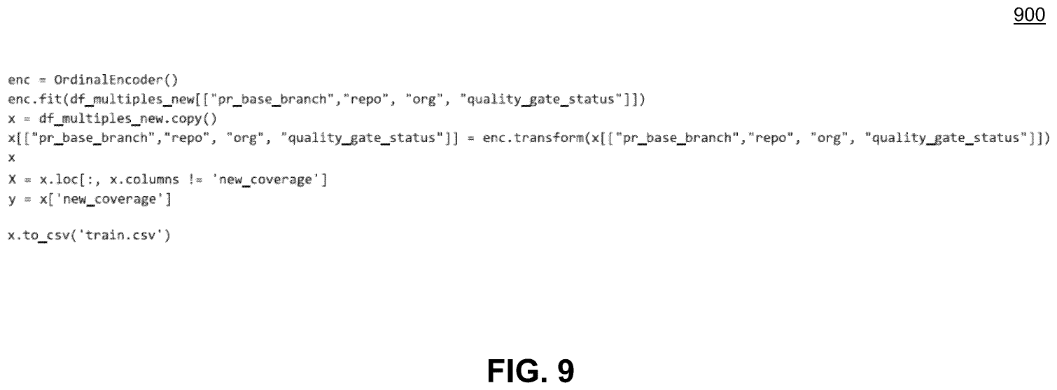

Since machine learning works with vectors (e.g., numbers), categorical and textual attributes must be encoded before being used as training data. In one or more embodiments, this can be achieved by leveraging a LabelEncoder function of ScikitLearn library. FIG. 9 depicts example pseudocode 900 for encoding and saving training and testing data samples as a CSV file.

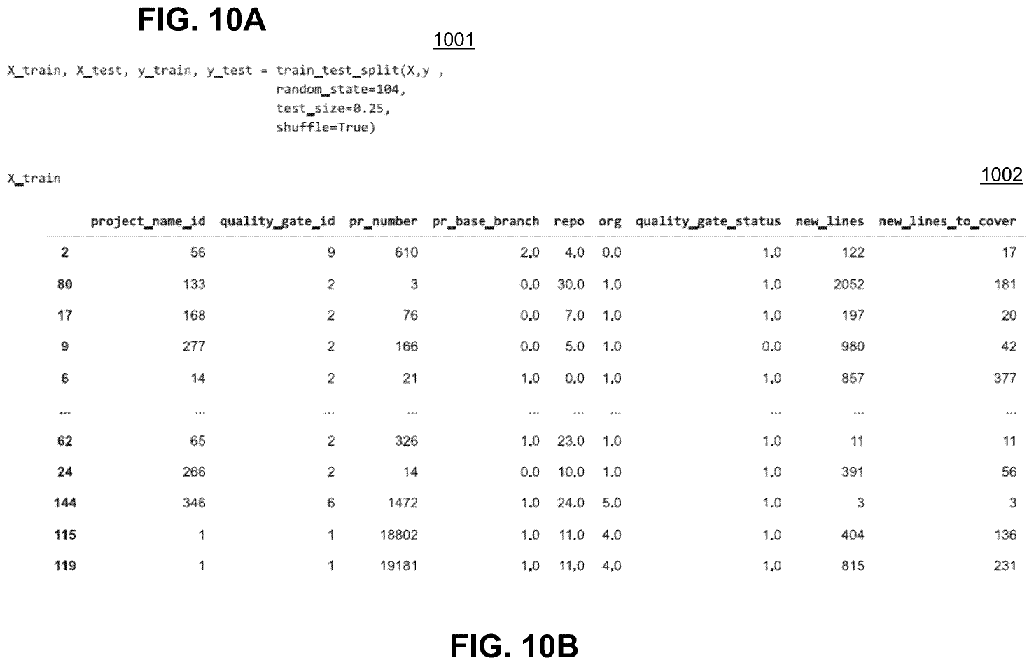

According to illustrative embodiments, the encoded training dataset is split into training and testing datasets, and separate datasets are created for independent variables and dependent variables. FIG. 10A depicts example pseudocode 1001 for splitting a dataset into training and testing components and for creating separate datasets for independent (X) and dependent (y) variables. The dataset is split into training and testing datasets using train_test_split function of ScikitLearn library with, for example, a 70%-30% split. FIG. 10B depicts a table 1002 of sample training data. The training data specifies, for example, the same 11 categories of data noted in connection with the table 700, which can be the same as the columns in the table 1002.

In an illustrative embodiment, categories 1-10 noted herein above in connection with the table 700 and table 1002 represent the independent (X) values. The dependent (y) variable (target variable) is identified as “new_coverage,” which is a predicted value corresponding to the quality of the code based on the independent variables. The dependent (y) variable represents the quality of coverage of new lines of code introduced in a pull request, and is crucial for understanding and improving the coverage of new code introduced into a codebase. The dependent (y) variable may be, for example, a numerical value, which will result in a conclusion of a reduction of code quality caused by the code change if the numerical value is below a designated quality threshold value. Alternatively, the dependent (y) variable may be one of a binary output indicating, for example, “yes” or “no” whether there is a reduction of code quality.

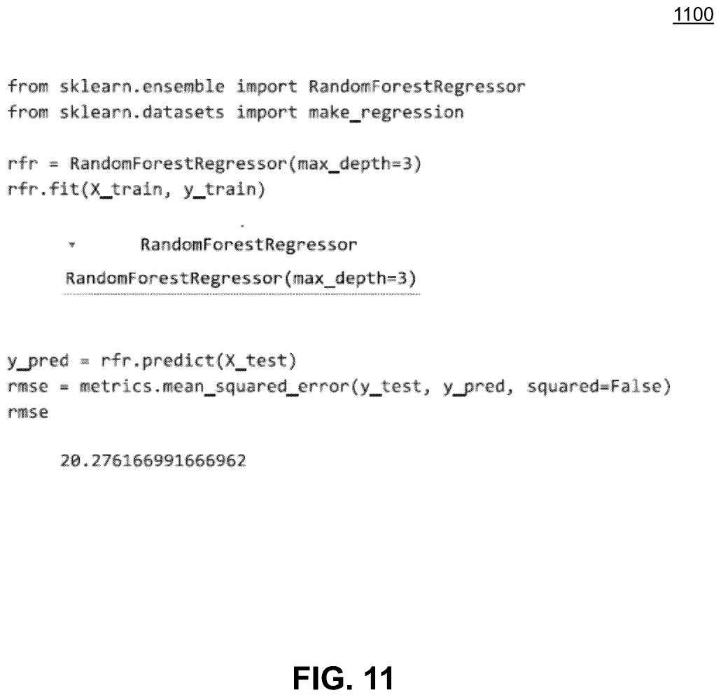

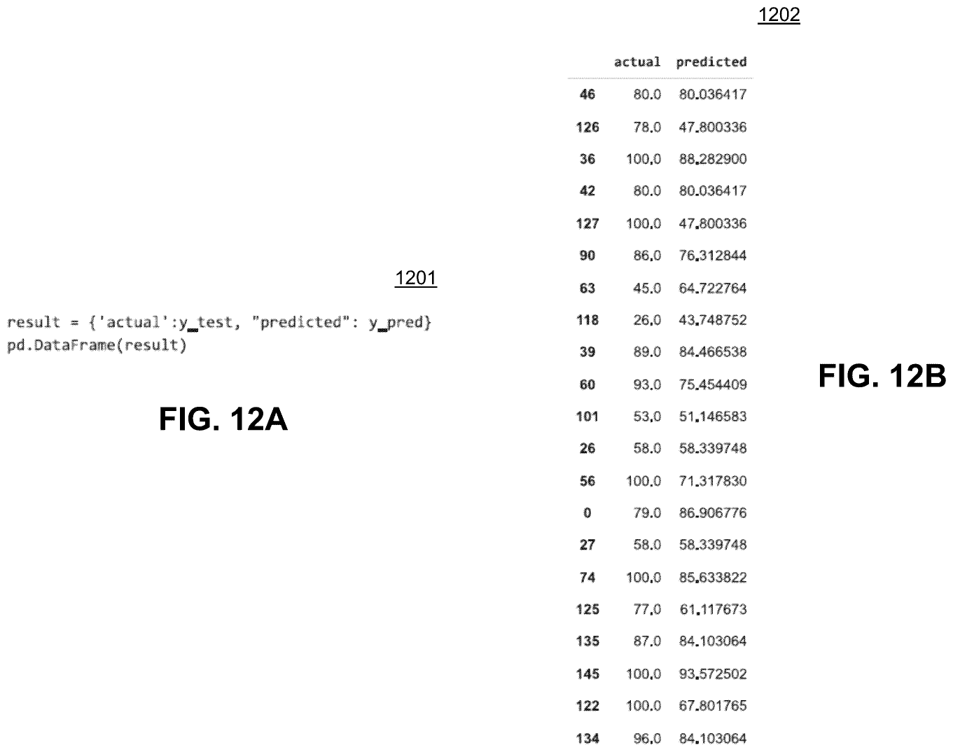

Once the datasets are ready for training and testing, a random forest regression model is created using a ScikitLearn library. FIG. 11 depicts example pseudocode 1100 for assembling the random forest regression model and setting a loss function, metrics and an optimizer of random forest regression model. Referring to the pseudocode 1100, the functional model specifies a maximum depth of the random forest regressor. Once the model is created, “mean_squared error” is used as the loss function and “mse” is used as a validation metric. As can be seen in FIG. 11, the error is about 20%, resulting in a precision level of approximately 80% with the random forest regression algorithm. FIG. 12A depicts example pseudocode 1201 for generating predicted values of the machine learning model and actual values. FIG. 12B depicts a table 1202 of predicted values of the machine learning model versus actual values. In connection with the training of the random forest regression model, as new data regarding model accuracy and whether and/or how much code quality is actually being reduced is collected, the model is iteratively retrained with the collected data to improve its accuracy.

In addition to being used as training data to iteratively train the random forest regression model, the processed data from the database 123 is input to the machine learning model to predict whether changes made to code are causing a reduction in quality of the code. Pioneering the art of foreseeing and predicting potential declines in software code quality. By harnessing data-driven analytics of data harnessed from code scans in response to proposed code changes, the machine learning and prediction engine 124 proactively predicts when code quality may weaken, advantageously allowing for preemptive measures to maintain and enhance overall software quality. In illustrative embodiments, the modified code is uploaded as a PDF file to developer devices 102 and also uploaded to a code repository 115 of a DevOps platform 105.

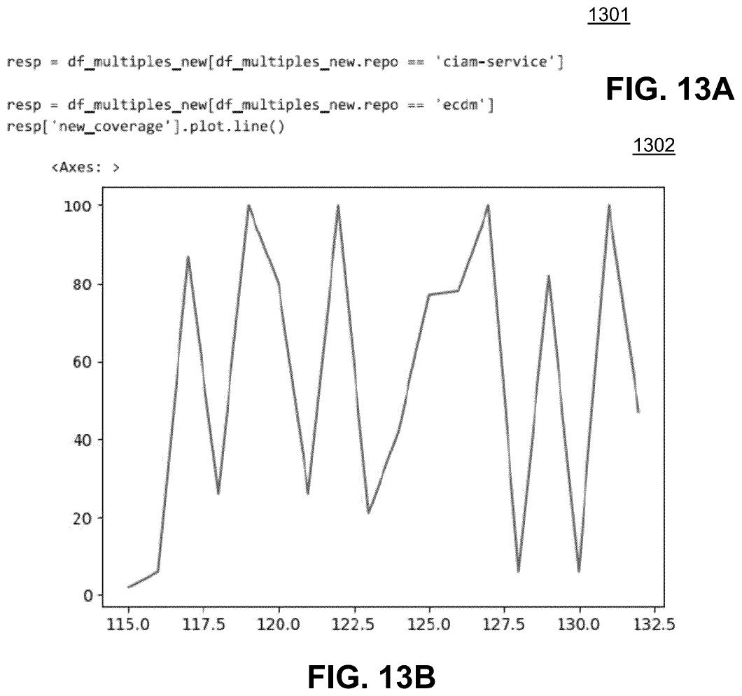

In illustrative embodiments, the predictive capabilities of the machine learning model used by the machine learning and prediction engine 124 are continuously applied to an enterprise copy data management (eCDM) repository under the organization “data manager.” This ongoing prediction process advantageously allows for effective prediction of future code quality. FIG. 13A depicts example pseudocode 1301 for continuously applying machine learning prediction to an ECDM repository, and FIG. 13B depicts a plot 1302 of results of continuously applying the machine learning prediction to an eCDM repository. In more detail, the plot 1302 comprises a Python data visualization based on a dataset. The x-axis (horizontal axis) represents code coverage, while the y-axis (vertical axis) represents the pull request number. The three Python statements in the example pseudocode 1301 are responsible for generating the plot 1302.

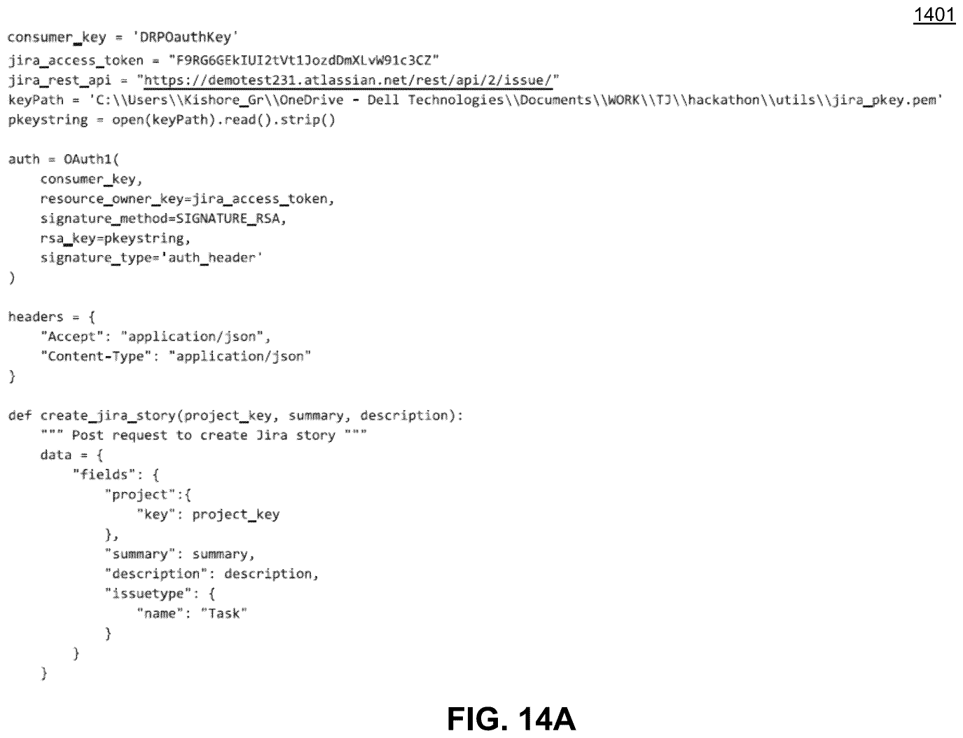

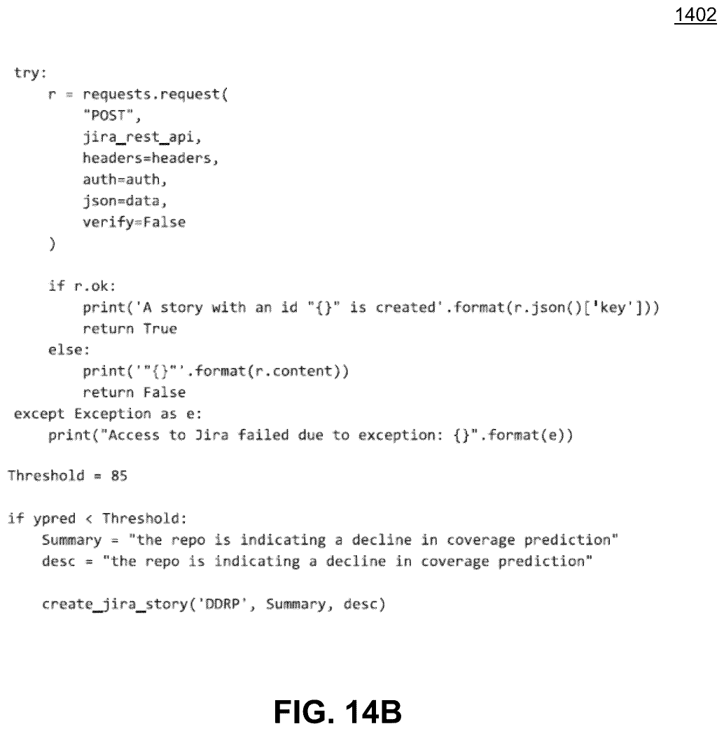

Referring to step 209 of the operational flow 200, in response to a prediction that one or more code changes will cause a reduction in quality of the code by the machine learning and prediction engine 124, the integration and placeholder creation engine 125 generates a placeholder in a code development application to address the reduction. In a non-limiting illustrative embodiment, the integration and placeholder creation engine 125 automatically creates a placeholder in a Jira® code development application. A module can be integrated into the integration and placeholder creation engine 125 which is used to create the placeholder. The module may be compatible with one or more programming languages (e.g., Python). The placeholders will eventually become part of the organization “data manager” for integration projects, thereby enhancing project management and workflow efficiency. FIGS. 14A and 14B depict example pseudocode 1401 and 1402 for creating a placeholder in a code development application, where the placeholder indicates a code issue.

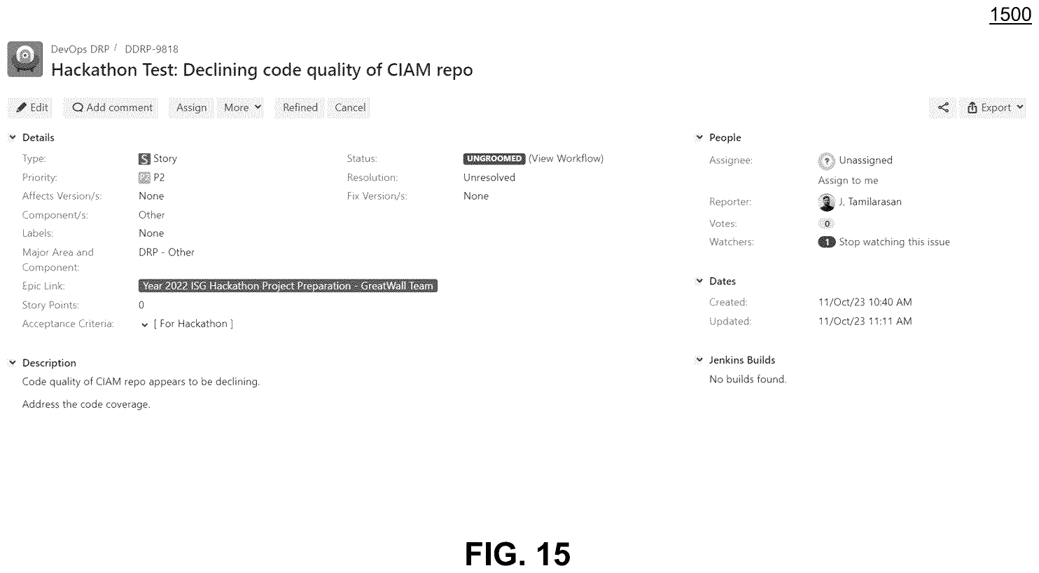

FIG. 15 depicts a screenshot 1500 of a placeholder for a software analysis system indicating a code issue according to an illustrative embodiment. The placeholder shown in the screenshot specifies, for example, a priority, a code version, one or more components corresponding to the code, a resolution status, a creation date of the placeholder and an update date of the placeholder.

In some embodiments, the database 123 and other data corpuses, repositories or databases referred to herein are implemented using one or more storage systems or devices associated with the code quality management platform 120. In some embodiments, one or more of the storage systems utilized to implement the database 123 and other data corpuses, repositories or databases referred to herein comprise a scale-out all-flash content addressable storage array or other type of storage array.

The term “storage system” as used herein is therefore intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although shown as elements of the code quality management platform 120, the code analysis and testing engine 121, webhook integration and microservice development engine 122, database 123, machine learning and prediction engine 124 and/or integration and placeholder creation engine 125 in other embodiments can be implemented at least in part externally to the code quality management platform 120, for example, as stand-alone servers, sets of servers or other types of systems coupled to the network. For example, the code analysis and testing engine 121, webhook integration and microservice development engine 122, database 123, machine learning and prediction engine 124 and/or integration and placeholder creation engine 125 may be provided as cloud services accessible by the code quality management platform 120.

The code analysis and testing engine 121, webhook integration and microservice development engine 122, database 123, machine learning and prediction engine 124 and/or integration and placeholder creation engine 125 in the FIG. 1 embodiment are each assumed to be implemented using at least one processing device. Each such processing device generally comprises at least one processor and an associated memory, and implements one or more functional modules for controlling certain features of the code analysis and testing engine 121, webhook integration and microservice development engine 122, database 123, machine learning and prediction engine 124 and/or integration and placeholder creation engine 125.

At least portions of the code quality management platform 120 and the elements thereof may be implemented at least in part in the form of software that is stored in memory and executed by a processor. The code quality management platform 120 and the elements thereof comprise further hardware and software required for running the code quality management platform 120, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

Although the code analysis and testing engine 121, webhook integration and microservice development engine 122, database 123, machine learning and prediction engine 124, integration and placeholder creation engine 125 and other elements of the code quality management platform 120 in the present embodiment are shown as part of the code quality management platform 120, at least a portion of the code analysis and testing engine 121, webhook integration and microservice development engine 122, database 123, machine learning and prediction engine 124, integration and placeholder creation engine 125 and other elements of the code quality management platform 120 in other embodiments may be implemented on one or more other processing platforms that are accessible to the code quality management platform 120 over one or more networks. Such elements can each be implemented at least in part within another system element or at least in part utilizing one or more stand-alone elements coupled to the network.

It is assumed that the code quality management platform 120 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the code analysis and testing engine 121, webhook integration and microservice development engine 122, database 123, machine learning and prediction engine 124, integration and placeholder creation engine 125 and other elements of the code quality management platform 120, and the elements thereof can each be implemented in the form of one or more LXCs running on one or more VMs. Other arrangements of one or more processing devices of a processing platform can be used to implement the code analysis and testing engine 121, webhook integration and microservice development engine 122, database 123, machine learning and prediction engine 124 and integration and placeholder creation engine 125, as well as other elements of the code quality management platform 120. Other portions of the system 100 can similarly be implemented using one or more processing devices of at least one processing platform.

Distributed implementations of the system 100 are possible, in which certain elements of the system reside in one data center in a first geographic location while other elements of the system reside in one or more other data centers in one or more other geographic locations that are potentially remote from the first geographic location. Thus, it is possible in some implementations of the system 100 for different portions of the code quality management platform 120 to reside in different data centers. Numerous other distributed implementations of the code quality management platform 120 are possible.

Accordingly, one or each of the code analysis and testing engine 121, webhook integration and microservice development engine 122, database 123, machine learning and prediction engine 124, integration and placeholder creation engine 125 and other elements of the code quality management platform 120 can each be implemented in a distributed manner so as to comprise a plurality of distributed elements implemented on respective ones of a plurality of compute nodes of the code quality management platform 120.

It is to be appreciated that these and other features of illustrative embodiments are presented by way of example only, and should not be construed as limiting in any way. Accordingly, different numbers, types and arrangements of system elements such as the code analysis and testing engine 121, webhook integration and microservice development engine 122, database 123, machine learning and prediction engine 124, integration and placeholder creation engine 125 and other elements of the code quality management platform 120, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

For example, as indicated previously, in some illustrative embodiments, functionality for the code quality management platform can be offered to cloud infrastructure customers or other users as part of FaaS, CaaS and/or PaaS offerings.

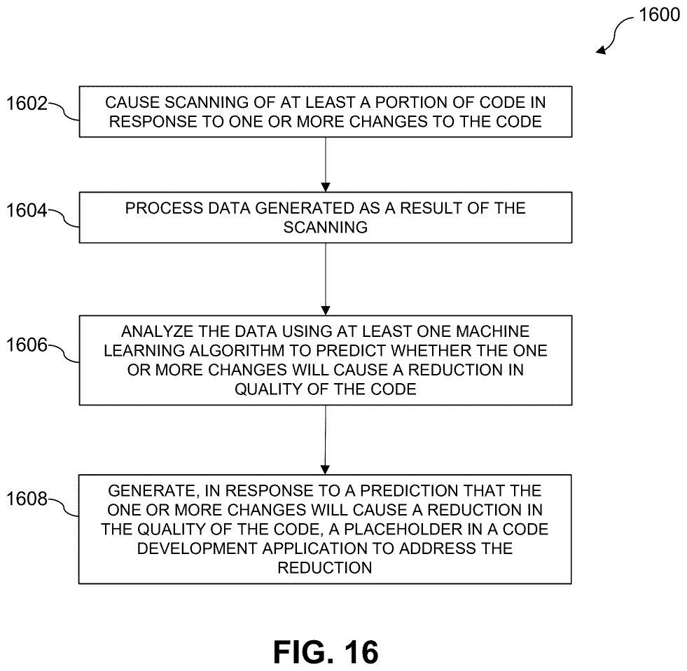

The operation of the information processing system 100 will now be described in further detail with reference to the flow diagram of FIG. 16. With reference to FIG. 16, a process 1600 for code quality management as shown includes steps 1602 through 1608, and is suitable for use in the system 100 but is more generally applicable to other types of information processing systems comprising a code quality management platform configured for predicting code quality and generating placeholders.

In step 1602, scanning of at least a portion of code is caused in response to one or more changes to the code. In illustrative embodiments, a code repository is continuously monitored to detect the one or more changes to the code. Detecting the one or more changes to the code may comprise identifying at least one pull request generated in connection with the code.

In step 1604, data generated as a result of the scanning is processed. In illustrative embodiments, an event-triggered function (e.g., webhook) is integrated with at least one code scanning application to trigger the processing and trigger loading of the data into at least one database in response to the scanning. The at least one database may comprise an SQL database. The event-triggered function is utilized to develop at least one API to process and load the data into the at least one database. The API can be part of at least one microservice that uses one or more ORM techniques to enable input-output operations on the database, wherein the input-output operations comprise CRUD operations. The at least one microservice is developed using a web-based API generation platform corresponding to at least one programming language. The at least one microservice supports a plurality of schemas and a plurality of data types.

In step 1606, the data is analyzed using at least one machine learning algorithm to predict whether the one or more changes will cause a reduction in quality of the code. The data is extracted from the database, and at least a portion of the data is used to train the at least one machine learning algorithm. In illustrative embodiments, the at least one machine learning algorithm comprises a random forest regression algorithm. In illustrative embodiments, the data to train the at least one machine learning algorithm specifies at least one of a number of new lines of the code and a base branch of the code.

In step 1608, in response to a prediction that the one or more changes will cause a reduction in the quality of the code, a placeholder in a code development application is generated to address the reduction. The placeholder specifies at least one of a priority, a code version, one or more components corresponding to the code, a resolution status, a creation date of the placeholder and an update date of the placeholder.

It is to be appreciated that the FIG. 16 process and other features and functionality described above can be adapted for use with other types of information systems configured to execute code quality management services in a code quality management platform or other type of platform.

The particular processing operations and other system functionality described in conjunction with the flow diagram of FIG. 16 are therefore presented by way of illustrative example only, and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 16 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems with a code quality management platform as disclosed herein can provide a number of significant advantages relative to conventional arrangements. For example, the code quality management platform implements continuous integration tools, code scanning, and automated placeholder generation to ensure that code quality is assessed at every stage, significantly reducing the likelihood of overlooked critical issues. By harnessing machine learning techniques and predictive models, the code quality management platform empowers teams to anticipate and address potential code quality issues before they become more significant, ultimately enhancing software reliability.

As an additional advantage, the integration of microservices, an API generation framework, and a PostgreSQL database streamlines data management, enabling real-time data extraction, transformation and loading, fostering more efficient decision-making. The seamless creation of software analysis system (e.g., Jira®) placeholders and their integration into the projects of an organization enhances project management capabilities, streamlining workflows and fostering collaboration across a development team.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the code quality management platform 120 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system and a code quality management platform in illustrative embodiments. These and other cloud-based systems in illustrative embodiments can include object stores.

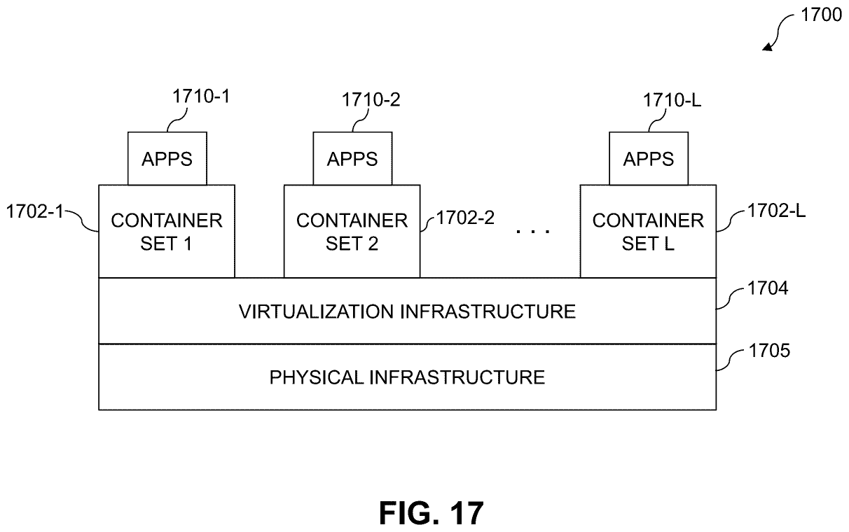

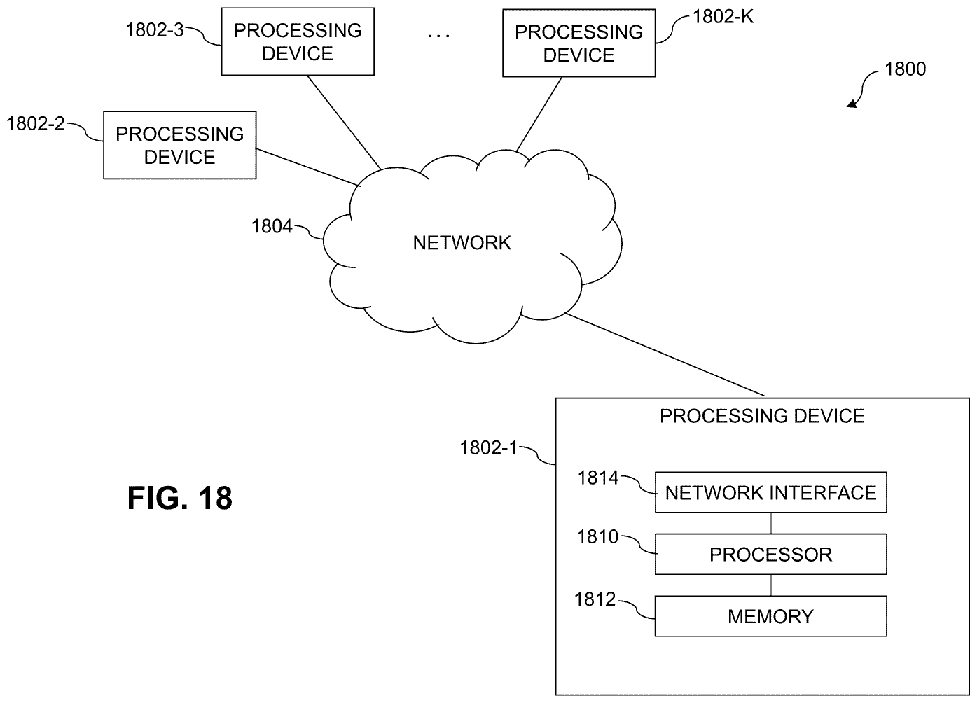

Illustrative embodiments of processing platforms will now be described in greater detail with reference to FIGS. 17 and 18. Although described in the context of system 100, these platforms may also be used to implement at least portions of other information processing systems in other embodiments.

FIG. 17 shows an example processing platform comprising cloud infrastructure 1700. The cloud infrastructure 1700 comprises a combination of physical and virtual processing resources that may be utilized to implement at least a portion of the information processing system 100. The cloud infrastructure 1700 comprises multiple virtual machines (VMs) and/or container sets 1702-1, 1702-2, . . . 1702-L implemented using virtualization infrastructure 1704. The virtualization infrastructure 1704 runs on physical infrastructure 1705, and illustratively comprises one or more hypervisors and/or operating system level virtualization infrastructure. The operating system level virtualization infrastructure illustratively comprises kernel control groups of a Linux operating system or other type of operating system.

The cloud infrastructure 1700 further comprises sets of applications 1710-1, 1710-2, . . . 1710-L running on respective ones of the VMs/container sets 1702-1, 1702-2, . . . 1702-L under the control of the virtualization infrastructure 1704. The VMs/container sets 1702 may comprise respective VMs, respective sets of one or more containers, or respective sets of one or more containers running in VMs.

In some implementations of the FIG. 17 embodiment, the VMs/container sets 1702 comprise respective VMs implemented using virtualization infrastructure 1704 that comprises at least one hypervisor. A hypervisor platform may be used to implement a hypervisor within the virtualization infrastructure 1704, where the hypervisor platform has an associated virtual infrastructure management system. The underlying physical machines may comprise one or more distributed processing platforms that include one or more storage systems.

In other implementations of the FIG. 17 embodiment, the VMs/container sets 1702 comprise respective containers implemented using virtualization infrastructure 1704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1700 shown in FIG. 17 may represent at least a portion of one processing platform. Another example of such a processing platform is processing platform 1800 shown in FIG. 18.

The processing platform 1800 in this embodiment comprises a portion of system 100 and includes a plurality of processing devices, denoted 1802-1, 1802-2, 1802-3, . . . 1802-K, which communicate with one another over a network 1804.

The network 1804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1802-1 in the processing platform 1800 comprises a processor 1810 coupled to a memory 1812. The processor 1810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1812 may comprise random access memory (RAM), read-only memory (ROM), flash memory or other types of memory, in any combination. The memory 1812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1802-1 is network interface circuitry 1814, which is used to interface the processing device with the network 1804 and other system components, and may comprise conventional transceivers.

The other processing devices 1802 of the processing platform 1800 are assumed to be configured in a manner similar to that shown for processing device 1802-1 in the figure.

Again, the particular processing platform 1800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the code quality management platform 120 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and code quality management platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
causing scanning of at least a portion of code in response to one or more changes to the code;
processing data generated as a result of the scanning;
analyzing the data using at least one machine learning algorithm to predict whether the one or more changes will cause a reduction in quality of the code; and
generating, in response to a prediction that the one or more changes will cause a reduction in the quality of the code, a placeholder in a code development application to address the reduction;
wherein the steps of the method are executed by a processing device operatively coupled to a memory.

2. The method of claim 1 further comprising continuously monitoring a code repository to detect the one or more changes to the code.

3. The method of claim 2 wherein detecting the one or more changes to the code comprises identifying at least one pull request generated in connection with the code.

4. The method of claim 1 further comprising integrating an event-triggered function with at least one code scanning application to trigger the processing of the data and loading of the data into at least one database in response to the scanning.

5. The method of claim 4 further comprising utilizing the event-triggered function to develop at least one application programming interface to process the data and load the data into the at least one database, wherein the at least one database comprises a structured query language database.

6. The method of claim 5 wherein the application programming interface is part of at least one microservice that uses one or more object-relational mapping techniques to enable input-output operations on the at least one database.

7. The method of claim 6 wherein the input-output operations comprise create, read, update and delete operations.

8. The method of claim 6 wherein the at least one microservice is developed using a web-based application programming interface generation platform corresponding to at least one programming language.

9. The method of claim 6 wherein the at least one microservice supports a plurality of schemas and a plurality of data types.

10. The method of claim 1 further comprising:
loading the data to at least one database;
extracting the data from the at least one database; and
using at least a portion of the data to train the at least one machine learning algorithm.

11. The method of claim 10 wherein at least a portion of the data to train the at least one machine learning algorithm specifies at least one of a number of new lines of the code and a base branch of the code.

12. The method of claim 1 wherein the at least one machine learning algorithm comprises a random forest regression algorithm.

13. The method of claim 1 wherein the placeholder specifies at least one of a priority, a code version, one or more components corresponding to the code, a resolution status, a creation date of the placeholder and an update date of the placeholder.

14. An apparatus comprising:
a processing device operatively coupled to a memory and configured:
to cause scanning of at least a portion of code in response to one or more changes to the code;
to process data generated as a result of the scanning;
to analyze the data using at least one machine learning algorithm to predict whether the one or more changes will cause a reduction in quality of the code; and
to generate, in response to a prediction that the one or more changes will cause a reduction in the quality of the code, a placeholder in a code development application to address the reduction.

15. The apparatus of claim 14 wherein the processing device is further configured to continuously monito a code repository to detect the one or more changes to the code.

16. The apparatus of claim 14 wherein the processing device is further configured to integrate an event-triggered function with at least one code scanning application to trigger the processing of the data and loading of the data into at least one database in response to the scanning.

17. The apparatus of claim 16 wherein the processing device is further configured to utilize the event-triggered function to develop at least one application programming interface to process the data and load the data into the at least one database, wherein the at least one database comprises a structured query language database.

18. An article of manufacture comprising a non-transitory processor-readable storage medium having stored therein program code of one or more software programs, wherein the program code when executed by at least one processing device causes said at least one processing device to perform the steps of:
causing scanning of at least a portion of code in response to one or more changes to the code;
processing data generated as a result of the scanning;
analyzing the data using at least one machine learning algorithm to predict whether the one or more changes will cause a reduction in quality of the code; and
generating, in response to a prediction that the one or more changes will cause a reduction in the quality of the code, a placeholder in a code development application to address the reduction.

19. The article of manufacture of claim 18 wherein the program code further causes said at least one processing device to perform the step of integrating an event-triggered function with at least one code scanning application to trigger the processing of the data and loading of the data into at least one database in response to the scanning.

20. The article of manufacture of claim 19 wherein the program code further causes said at least one processing device to perform the step of utilizing the event-triggered function to develop at least one application programming interface to process the data and load the data into the at least one database, wherein the at least one database comprises a structured query language database.
